(19) United States
(12) Patent Application Publication
(10) Pub. No.: US 2007/0107993 A1
(43) Pub. Date: May 17, 2007

(54) Guide rail for an elevator system

(76) Inventors: Robin Mihekun Miller, Ellington, CT (US); Vijay Jayachandran, Vernon, CT (US)

Correspondence Address: CARLSON GASKEY & OLDS, 400 W MAPLE STE 350, BIRMINGHAM, MI, 48009, US

(21) Appl. No.: 10/580,939

(22) PCT Filed: Dec. 9, 2003
(86) PCT No.: PCT/US03/39076

§ 371 Date: May 30, 2006

(51) Int. Cl. B66B 7/02

(52) U.S. Cl. 187/406

(57) ABSTRACT

A guide rail (24) for an elevator system (20) includes an aluminum body having a base portion (30) and a nose portion (32). A covering (40), which is made from a steel sheet in one example, covers over a distal end (36) of the nose portion (32) to provide a braking surface for a conventional braking device to selectively prevent movement of an elevator car (22). In one example, a high temperature bonding material (42) secures the covering to the nose portion of the guide rail. In one example, the guide rail body is made from extruded aluminum and the covering comprises steel.

### FIELD OF THE INVENTION

This invention generally relates to guide rails for elevator systems. More particularly, this invention relates to elevator guide rails made from a lightweight material with a more wear-resistant material on at least a portion of the rail to provide a braking surface.

### DESCRIPTION OF THE RELATED ART

Elevator systems typically include guide rails that guide movement of a car within a hoistway. Conventional guide rails are made of steel. While steel guide rails provide a stable structure that is able to provide the necessary guiding function and provide a braking surface during braking operations, they are not without drawbacks. Steel guide rails are heavy and relatively expensive. A significant portion of the installation time associated with installing an elevator system is devoted to installing the guide rails. When steel guide rails are used, their heavy and awkward nature contributes to the additional labor cost. Additionally, the running surface along which guide rollers travel during elevator car movement must be machined into the steel using a separate machine process.

One attempt to avoid using steel guide rails has been to utilize aluminum guide rails. A significant shortcoming associated with aluminum guide rails is that the aluminum material is not hard enough to withstand the surface forces associated with an elevator braking operation. This is particularly true in safety braking situations where the elevator car is traveling at a high speed before being stopped. The heat associated with a braking operation can reach the melting point of aluminum, which significantly degrades the rail. Additionally, typical braking materials used in elevator systems are hard and scar the surface of an aluminum rail. Accordingly, while aluminum rails provide cost savings from a materials and installation standpoint, and an improved running surface, they do not typically provide adequate properties for required elevator system operation.

This invention provides the ability to use an aluminum guide rail structure that is adapted to withstand the conditions associated with braking applications in an elevator system.

### SUMMARY OF THE INVENTION

In general terms, this invention is a two-material guide rail that is more economical and yet as durable as a conventional steel rail.

One example guide rail designed according to this invention includes a body made of a first material. The body includes a nose portion that provides a guiding surface along which guide rollers travel during elevator car movement. A second material covering extends over at least part of the nose portion and provides a braking surface against which elevator bralke components act during a braking application.

In one example, the guide rail body is made from aluminum and the cover is made from steel.

In one example, a bonding agent secures the steel covering to the appropriate portion of the aluminum guide rail. The bonding agent in one example is thermally conductive so that it assists in dissipating heat that tends to build up in a brake member during a braking application.

In one example, the covering is an elongated, bent clip made from a steel sheet that closely surrounds the brake area on the nose portion of an aluminum guide rail. The covering provides a durable steel surface for direct contact with brake pads. In one example, the formed steel sheet extends continuously along the entire length of the guide rail.

A guide rail designed according to this invention provides all of the advantages associated with using a lightweight material such as aluminum to form the guide rail body yet provides the durability such as that associated with steel guide rails for braking applications, for example.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 schematically and diagrammatically illustrates selected components of an elevator system designed according to an embodiment of this invention.

FIG. 2 is a cross-sectional illustration of an example guide rail embodiment as seen along the lines 2-2 in FIG. 1.

FIG. 3 illustrates a selected portion of the embodiment of FIG. 2.

FIG. 4 is a cross-sectional illustration similar to that in FIG. 2 but of an alternative embodiment of a guide rail designed according to this invention.

FIG. 5 is a cross-sectional illustration similar to that in FIG. 2 but of an alternative embodiment.

FIG. 6 schematically illustrates, in perspective view, another example cover useful with an embodiment of a guide rail designed according to this invention.

FIG. 7 is a cross-sectional illustration similar to that in FIG. 2, but showing an embodiment incorporating the cover illustrated in FIG. 6.

FIG. 8 schematically shows a portion of an example installation process.

### DETAILED DESCRIPTION OF THE PREFERRED EMBODIMENTS

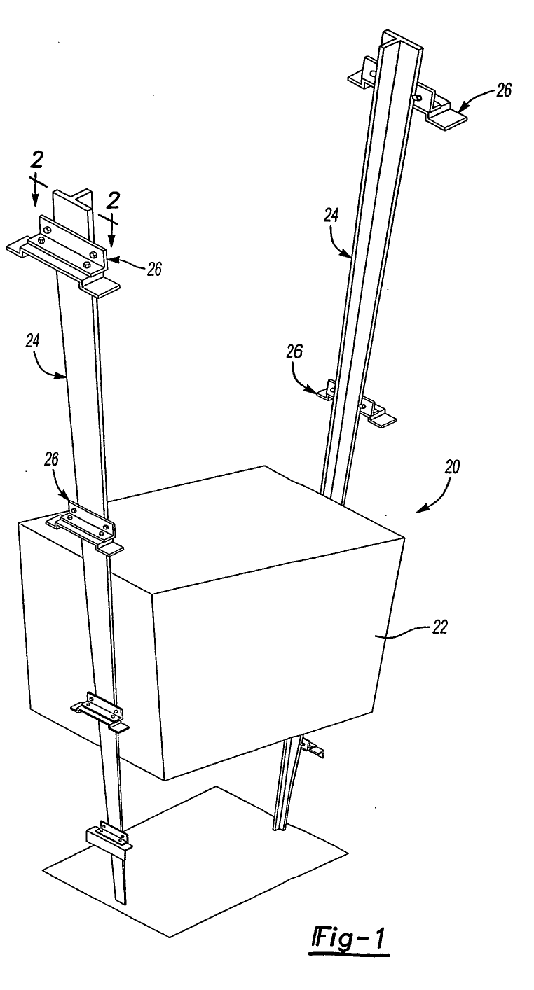

FIG. 1 schematically shows an elevator system 20 where a car 22 is supported for vertical movement and guided by guide rails 24. A plurality of mounting brackets 26 secure the guide rails 24 in a desired position within a hoistway (not illustrated) in a known manner.

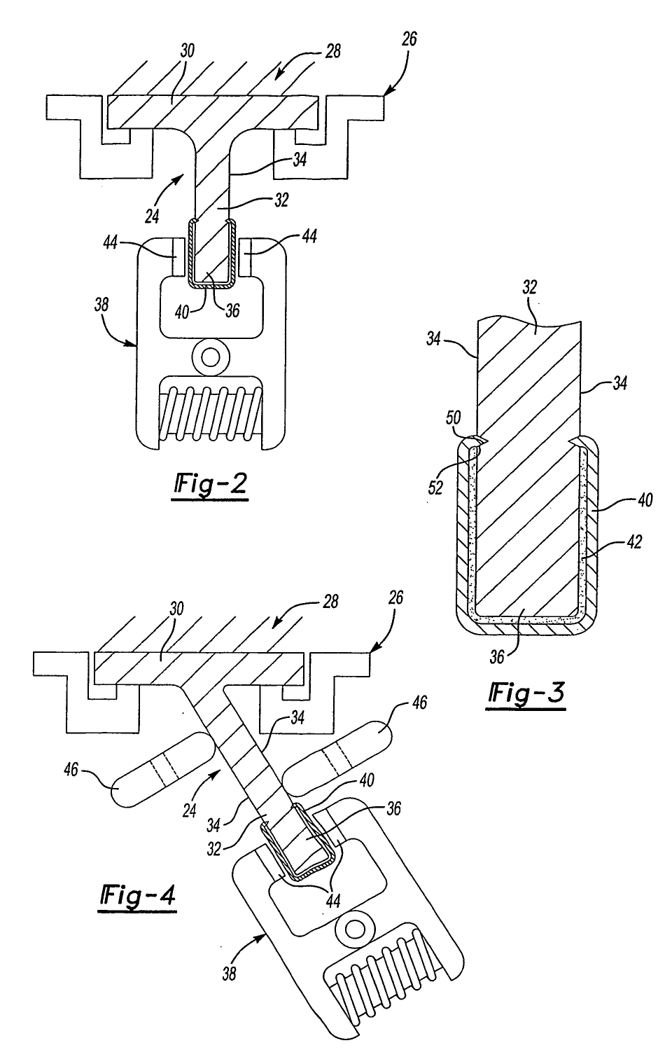

As best appreciated from FIGS. 2 and 4, the guide rails 24 are made of two different materials. The body of the guide rail includes a base portion 30 that is adapted to be secured relative to a stationary surface 28 in the hoistway, for example, using the conventional mounting brackets. A nose portion 32 extends away from the base portion 30. In the example of FIG. 2, the guide rail has a T-shaped cross section.

The nose portion 32 provides a guiding surface 34 on opposite sides of the nose portion 32. The guiding surface is configured to receive conventional guide rollers that travel along the guiding surface 34 for achieving a desired movement of the elevator car 22, for example.

A distal end 36 of the nose portion 32 provides a braking surface against which a braking device 38 can act to stop movement of the elevator car 22 in a conventional manner. As best appreciated from FIG. 3, a covering 40 made from a different material than the guide rail body covers over at least a portion of the distal end 36 of the nose portion 32. In this example, the covering 40 comprises a steel sheet that is formed as a clip that fits over the distal end 36 of the nose portion 32.

In one example, the covering 40 comprises steel while the guide rail body comprises aluminum.

In this example a bonding agent 42 is located between the covering 40 and the nose portion 32 to secure the covering 40 in place. The bonding agent preferably is selected to provide sufficient shear strength to avoid any relative longitudinal movements between the distal end 36 of the nose portion 32 and the covering 40. In one example, a thermally conductive bonding agent is utilized to distribute heat associated with a braking application. Example bonding agents that are useful with guide rails designed according to this invention include polymer-based adhesives, concrete and concrete-like adhesives.

In one example, the high temperature bonding material is distributed evenly throughout the contact area between the steel covering 40 and the aluminum nose portion 32. The bonding material preferably has a high compressive strength to prevent any fracture that might otherwise occur responsive to the squeezing forces associated with brakes acting against the covering 40 on the rail 24. The covering 40 provides a durable surface for direct contact with conventional elevator system brake pads.

In one example, the covering 40 is essentially a clip formed from a continuously bent roll of sheet metal and provides a continuous braking surface along the entire longitudinal length of the rail 24. In one example, the clip of sheet steel is formed at the elevator system installation site from a roll of sheet metal using a conventional forming tool, for example.

During operation of the braking device 38 brake pads 44 engage the outer surface of the covering 40. The heat generated at the interface between the pads 44 and the covering 40 is distributed along a length of the rail where the braking occurs. Once the elevator car 22 has come to a stop, however, a highly concentrated amount of heat typically is stored within the brake pads 44. The so-called “soak-back” effect rapidly transfers heat to the portion of the rail 24 against which the brake pads 44 are resting. The covering 40 and the bonding material 42 in one example provide thermal resistance between the nose portion 32 of the aluminum rail and the brake pad surface. As the rail body has good thermal conductivity, the insulation thickness provided by the covering 40 and the bonding material 42 can be relatively small. As known, higher speed elevators will generate more heat during a braking application. Accordingly, the thickness of the covering 40 may be selected based upon the expected operating parameters of the elevator system. Those skilled in the art who have the benefit of this description will be able to decide what thickness of the covering 40 and the bonding material 42 will sufficiently curtail maximum heat transfer associated with the soak-back effect to prevent any softening of the aluminum while still allowing the rail to dissipate the heat energy at a required rate.

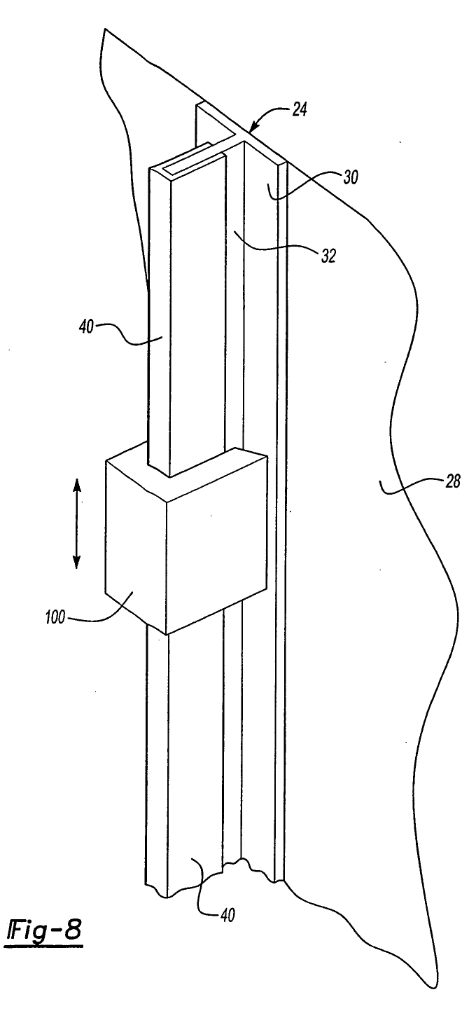

The bonding material 42 might soften upon soakback, but re-casts after such a heat cycle. This material could be mechanically captured inside the steel clip 40 upon installation onto the aluminum extrusion. In this example and as shown schematically in FIG. 8, after everything is in place (i.e., the rail body is installed in the hoistway), a robotic tool 100 progresses along the rail, heating the interface and casting the bond between the steel and aluminum while forming to exacting tolerances.

As schematically shown in FIG. 3, the example rail nose portion 32 includes a plurality of recesses 50 longitudinally spaced along the rail. The covering 40 includes projections 52 that extend at least partially into the recesses to stabilize the covering 40 relative to the end 36 of the nose portion 32. The projections 52 may be formed by crimping or deforming an appropriate portion of the covering to establish the desired connection.

FIG. 4 illustrates another example embodiment where the nose portion 32 extends away from the base portion 30 at an oblique angle. Utilizing aluminum as the material for forming the body of the rail allows for customizing the final shape of the rail without requiring any machining operations, which increases design flexibility and enhances system economies. Possible configurations include a single rail extrusion having car and counterweight guiding portions integrated into a single extrusion. The arrangement of FIG. 4 provides a guiding surface 34 along which guide rollers 46 travel and a braking surface provided by the covering 40 over the distal end 36 of the nose portion 32.

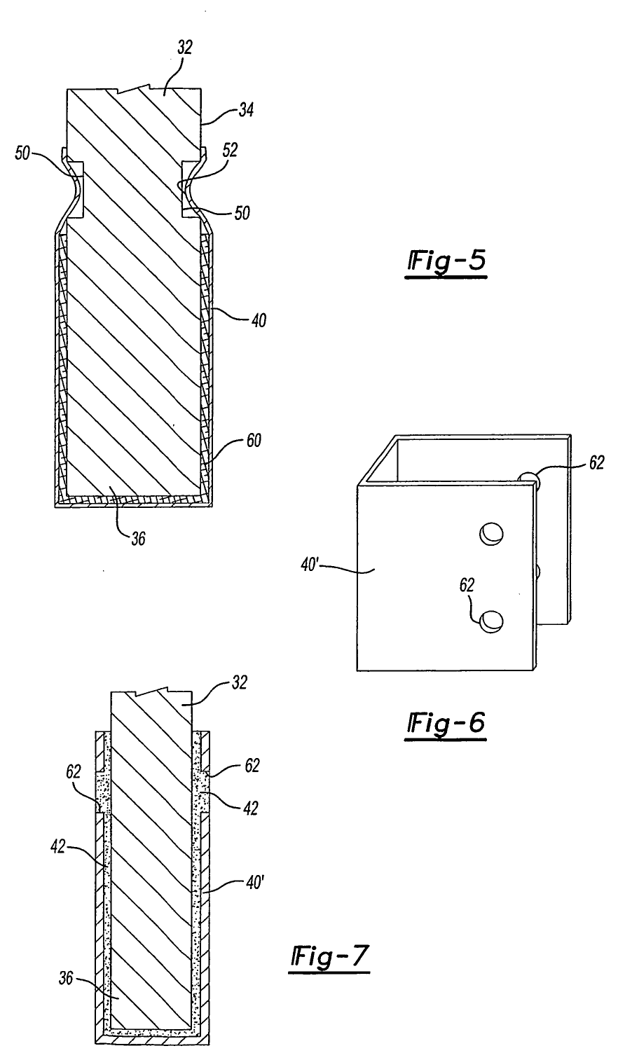

FIG. 5 illustrates another example arrangement where the nose portion 32 includes a plurality of recesses 50 longitudinally spaced along the rail similar to those shown in FIG. 3. In this example, there is no adhesive between the steel cover 40 and the distal end 36 of the nose portion 32. Instead, in this example, there is a mesh fabric that is made of glass fibers in one example. The fabric layer 60 provides high temperature insulation at the inner face between the covering 40 and the nose portion 32. The insulating fabric 60 avoids excessive temperature transferred to the aluminum material of the example nose portion 32.

In this example, the steel covering 40 is swaged or otherwise deformed at least partially into the recesses 50 to secure the covering 40 in place.

Another example includes using concrete as the bonding agent securing the covering 40 to the nose portion 32. FIG. 6 shows one example covering 40 that is made of a bent steel sheet. In this example, a plurality of openings 62 are formed in the covering 40. As can be appreciated from FIG. 7, when the bonding agent 42 extends into and effectively fills the openings 62. In this example, the bonding agent 42 is concrete. Allowing the concrete 42 to extend into the openings 62 provides compressive characteristics for loading to provide a secure bond that withstands breaking forces.

In one example designed according to the teachings of FIGS. 6 and 7, after the concrete 42 is supplied between the nose portion 32 and the inside of the covering 40′, any excess concrete extending out of the holes 62 is wiped off to ensure an appropriately continuous outer surface along the corresponding portion of the guide rail assembly.

In another example, the interior surface of the covering 40 and the exterior surface of the nose portion 32 are treated so that the surfaces are roughened. Such rough surfaces enhance the ability of a bonding agent like concrete to enhance compressive loading into the surface defects to provide a better bond between the covering and the rail nose portion.

A significant advantage of this invention is that it permits the use of aluminum for forming a guide rail body while still being able to withstand the forces associated with conventional braking applications in elevator systems. Extruding aluminum allows for making the rail into a final shape without requiring any machining for a guiding surface, for example. The ability to mount the rails within a hoistway is enhanced because of the lighter weight of aluminum and the additional ease of installation reduces the cost associated with labor for that portion of installing an elevator system. Further, lighter weight rails enable longer rails to be used, without increasing shipping cost, for example. Longer rail portions reduces the amount of joints along the rail within a building, which enhances system economies and improves the ride quality of the elevator car.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A guide rail for use in an elevator system, comprising:
a first material body having a nose portion; and
a second material secured to at least some of the nose portion, wherein the second material comprises steel.

2. The guide rail of claim 1, wherein the second material establishes a covering that extends along an entire longitudinal length of the guide rail covering at least some of the nose portion.

3. The guide rail of claim 1, wherein the second material comprises a steel sheet that is shaped to conform to the nose portion and including a bonding agent between the steel sheet and the nose portion.

4. The guide rail of claim 1, wherein the nose portion includes at least one recess and the second material has a portion extending at least partially into the recess.

5. The guide rail of claim 1, including an insulating layer between the nose portion and the second material.

6. The guide rail of claim 5, wherein the insulating layer comprises a fiber mesh.

7. The guide rail of claim 6, wherein the mesh comprises a glass fiber fabric.

8. A guide rail for use in an elevator system, comprising:
a first material body having a nose portion;
a second material secured to at least some of the nose portion; and
a bonding agent securing the second material to the nose portion.

9. The guide rail of claim 8, wherein the bonding agent comprises at least one of an adhesive or concrete.

10. A guide rail for use in an elevator system, comprising:
a first material body having a nose portion; and
a second material secured to at least some of the nose portion, wherein the nose portion has a guiding surface on opposite sides of the nose portion and a braking region near an end of the nose portion and wherein the second material is only on the braking region of the nose portion.

11. The guide rail of claim 10, wherein the second material is a covering that comprises a steel sheet extending over the braking region on each side of the nose portion.

12. The guide rail of claim 11, wherein the covering extends along an entire longitudinal length of the nose portion.

13. A guide rail for use in an elevator system, comprising:
a first material body having a nose portion; and
a second material secured to at least some of the nose portion, wherein the body comprises a base portion that is adapted to be secured to a stationary structure and the nose portion extends away from the base portion at an oblique angle.

14. A method of making a guide rail for use in an elevator system, comprising:
forming a rail body using a first material that comprises aluminum; and
covering at least a portion of the rail with a second material that comprises steel.

15. The method of claim 14, including forming an elongated clip comprising the second material and subsequently placing the clip over the corresponding portion of the rail body.

16. The method of claim 14, including forming some of the second material to extend into at least one recess on the rail body.

17. The method of claim 14, including installing the rail body in a hoistway and subsequently moving a tool along the installed rail body to secure the second material covering in place.

18. The method of claim 17, including using an automated robot that climbs the rail.

19. A method of making a guide rail for use in an elevator system, comprising:
forming a rail body using a first material;
covering at least a portion of the rail body with a second material; and
securing the second material to the rail body using a bonding agent.

20. A method of making a guide rail for use in an elevator system, comprising:
forming a rail body using a first material;
covering at least a portion of the rail body with a second material; and
forming the rail body to have a base and a nose portion and orienting the nose portion at an oblique angle relative to the base.

21. The guide rail of claim 1, wherein the first material comprises aluminum.
